(19) United States
(12) Patent Application Publication
(10) Pub. No.: US 2014/0052688 A1
(43) Pub. Date: Feb. 20, 2014

(54) System and Method for Matching Data Using Probabilistic Modeling Techniques

(71) Applicant: Opera Solutions, LLC, Jersey City, NJ (US)

(72) Inventor: Shubh Bansal, New Delhi (IN)

(73) Assignee: Opera Solutions, LLC, Jersey City, NJ (US)

(21) Appl. No.: 13/969,010

(22) Filed: Aug. 16, 2013

Related U.S. Application Data
(60) Provisional application No. 61/684,346, filed on Aug. 17, 2012.

(51) Int. Cl. G06N 7/02

(52) U.S. Cl. CPC G06N 7/02
USPC 706/52

(57) ABSTRACT

A system and method for matching data using probabilistic modeling techniques is provided. The system includes a computer system and a data matching model/engine. The present invention precisely and automatically matches and identifies entities from approximately matching short string text (e.g., company names, product names, addresses, etc.) by pre-processing datasets using a near-exact matching model and a fingerprint matching model, and then applying a fuzzy text matching model. More specifically, the fuzzy text matching model applies an Inverse Document Frequency function to a simple data entry model and combines this with one or more unintentional error metrics/measures and/or intentional spelling variation metrics/measures through a probabilistic model. The system can be autonomous and robust, and allow for variations and errors in text, while appropriately penalizing the similarity score, thus allowing dataset linking through text columns.

### CROSS-REFERENCE TO RELATED APPLICATION

This application claims priority to U.S. Provisional Patent Application No. 61/684,346 filed on Aug. 17, 2012, which is incorporated herein by reference in its entirety and made a part hereof.

### BACKGROUND OF THE INVENTION

1. Field of the Invention

The present invention relates generally to matching data from multiple independent sources. More specifically, the present invention relates to a system and method for matching data using probabilistic modeling techniques.

2. Related Art

In the field of data processing, reliable data matching across multiple data sets is of critical importance. For example, many databases contain many “name domains” which correspond to entities in the real world (e.g., course numbers, personal names, company names, place names, etc.), and there is often a need to identify matching data in such databases. Frequently, datasets from different data sources must be merged (e.g., customer matching, geo tagging, product matching, etc.). Such data consolidation tasks are fairly common across a variety of subject areas including academics (e.g., matching research publication citations) and government studies, such as for matching individuals/families to census data (e.g., evaluating the coverage of the U.S. decennial census), as well as matching administrative records and survey databases (e.g., creating an anonymized research database combining tax information from the Internal Revenue Service and data from the Current Population Survey).

For large datasets, manual matching is impractical, and for many datasets, databases are not designed to be linked. Consequently, statisticians and data analysts are often faced with the problem of linking/merging datasets across heterogeneous databases from different sources without clean and explicit linking keys. In such cases, a pseudo linking key is often used for merging, where the key comprises a combination of common variables.

However, in many circumstances, the only potential linking key is manually-entered, “messy” text data, such as shown below:

TABLE 1

| Dataset 1 (Company Name) | Dataset 2 (Company Name) |
|---|---|
| Koos Manufacturing, Inc. | Koos Manufacturing (AG Jeans) |
| VF Corp-Reef | VF Corp - Reef, Eagle Creek |
| Nike USA - Corp/Misc | Nike Inc. |
| Rossignol Softgoods | Rossigol Lange SpA |
| Kyocera Communications Inc | Kyocer Wireless Corp. |

Direct merging does not work if any one matching variable happens to be manually-entered text (e.g., customer names, company names, product names, addresses, etc.), since even small variations or errors can prevent the use of conventional exact merging techniques. This problem has been previously addressed using simple token similarity models/metrics (e.g., Jaccard Coefficient) and/or using character sequence similarity measures/metrics (e.g., Levenshtein distance, Jaro Winkler Distance, etc.). Used individually, these metrics are often unable to provide good performance based on real world data.

### SUMMARY OF THE INVENTION

The present invention relates to a system and method for matching data using probabilistic modeling techniques. The system includes a computer system and a data matching model/engine. The present invention precisely and automatically matches and identifies entities from approximately matching short string text (e.g., company names, product names, addresses, etc.) by pre-processing datasets using a near-exact matching model and a fingerprint matching model, and then applying a fuzzy text matching model. More specifically, the fuzzy text matching model applies an Inverse Document Frequency function to a simple data entry model and combines this with one or more unintentional error metrics/measures and/or intentional spelling variation metrics/measures through a probabilistic model. The system can be autonomous and robust, and allow for variations and errors in text, while appropriately penalizing the similarity score, thus allowing dataset linking through text columns.

### BRIEF DESCRIPTION OF THE DRAWINGS

The foregoing features of the invention will be apparent from the following Detailed Description of the Invention, taken in connection with the accompanying drawings, in which:

FIG. 1 is a flowchart showing overall processing steps carried out by the system;

FIG. 2 is a flowchart showing in greater detail the processing steps of the fuzzy text matching model implemented by the system to find matching data items;

FIG. 3 is a graph illustrating the Levenshtein distance between two tokens when varying token length;

FIG. 4 is a graph illustrating the average precision-recall performance curves of selected string similarity metrics on a benchmark dataset;

FIG. 5 is a graph illustrating the precision-recall performance of the data matching system of the present invention on three benchmark datasets; and

FIG. 6 is a diagram showing hardware and software components of the system of the present invention.

### DETAILED DESCRIPTION OF THE INVENTION

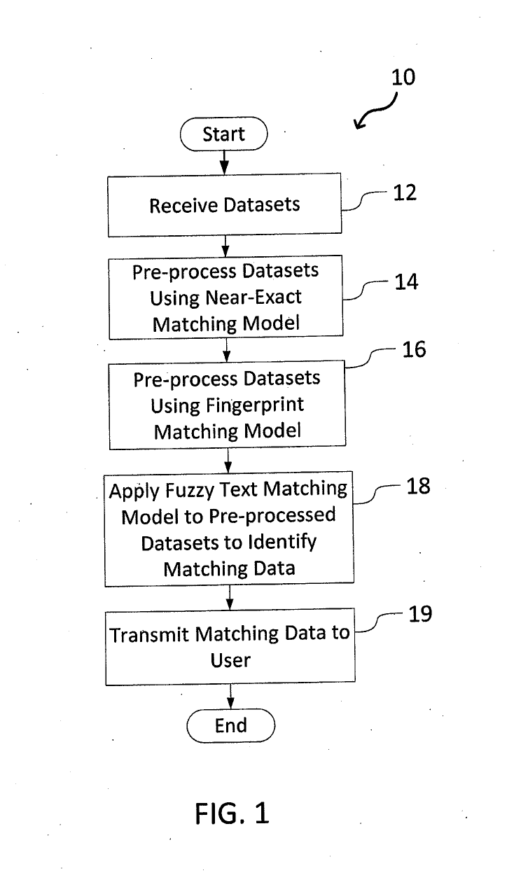

The present invention relates to a system and method for matching data using probabilistic modeling techniques, as discussed in detail below in connection with FIGS. 1-6.

FIG. 1 is a flowchart depicting overall processing steps 10 of the system of the present invention. Starting in step 12, the system receives datasets, usually from independent sources, that require combination (e.g., by linking data sources through a column containing manually entered data) or identification of matching data that may exist in the independent datasets. In step 14, the data is pre-processed by applying a “near-exact” matching model. In this step, all non alpha-numeric characters (e.g., punctuation, whitespaces, etc.) are removed, every remaining character is set to lower case, and the resultant strings are directly compared.

Proceeding to step 16, pre-processing continues with application of a fingerprint matching model to the data processed by the “near-exact” matching model. Fingerprint matching refers to a key collision method of clustering. A descriptions of suitable key collision methods, fingerprinting methods, and fingerprinting code is available at “ClusteringInDepth: Methods and theory behind the clustering functionality in Google Refine,” code.google.com/p/google-refine/wiki/ClusteringInDepth, the entirety of which is incorporated herein by reference. Clustering is the operation of finding groups of different values that have a high probability of being alternative representations of the same thing (e.g., “New York” and “new york”). Key collision methods are based on the idea of creating an alternative representation of a value that contains only the most valuable or meaningful part of a string. The fingerprint matching model in step 16 converts each entry into its text fingerprint, and then the fingerprints are directly compared. The fingerprint matching model implements one or more of the following operations (in any order) to generate a key or unique value from a string value: (1) remove leading and trailing whitespaces; (2) change all characters to their lowercase representation; (3) remove all punctuation and control characters; (4) split the string into whitespace-separated tokens; (5) sort the tokens and remove duplicates; and (6) normalize extended western characters to their ASCII representation (e.g., “gödel”→“godel”). In this way, a fingerprint divides a string into a set of tokens, and the least significant attributes in terms of differentiation are ignored (e.g., the order of tokens). As an example, the fingerprint for “Boston Consulting Group, the” and “Evr, Inc (Skinny Minnie)” would be {boston,consulting,group,the} and {evr,inc,minnie,skinny}, respectively.

Pre-processing steps 14 and 16 are extremely fast and can be done in O(n log m) time since they involve some transformations, followed by direct comparison. It is noted that the present invention could be implemented without pre-processing steps 14 and 16, although the execution time would increase.

In step 18, a fuzzy text matching model which includes probabilistic modeling techniques is applied to the pre-processed datasets to identify matching data which may exist in the datasets. This step can be time intensive since it requires comparisons between every remaining pair of names, where one is drawn from a first table, and the second from another. To list matches between text in two columns of sizes m and n, mn match probabilities must be computed, and then only the ones that clear a minimum threshold are kept. This is easily parallelizable, but the complexity remains O(mn). Therefore, in the interest of speed, preferably all pairs of names that have matched in the pre-processing steps 14 and 16 are removed. Finally, in step 19, any matching data items identified in step 18 are transmitted to the user, e.g., by way of a text file, report, etc.

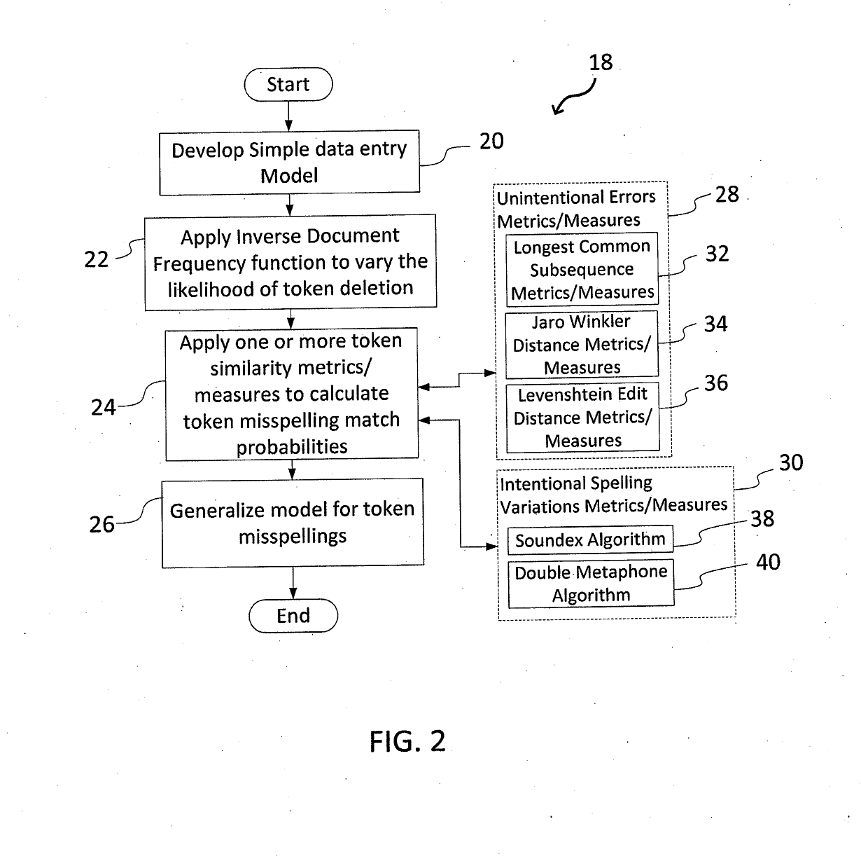

As shown in FIG. 2, the fuzzy text matching model 18 is described in greater detail. Starting in step 20, a simple probabilistic model is developed, which assumes Poisson behavior of data entry agents. Let A and B represent two sets of names (or columns) with elements to match, and assuming no duplication within either of A or B (e.g., no two names in A refer to the same entity). Also, let a third, inaccessible, set C contain all of the entities represented in A and B.

Every time a user enters data into A or B, he/she intends to textually represent some element of C. However, sometimes errors are made instead of typing out the full true textual representation. For purposes of this step, a token is a word, and errors are limited to token deletes, such that if A is a set of elements, each element of A is a set of tokens (e.g., “Opera Solutions” is comprised of tokens “opera” and “solutions”). As a result, the “true” textual representation of any element c in C is defined as the union of all the tokens that were typed in when the entity c was intended to be entered. For example, if some element of A were “Opera Solutions Management Consulting” and some element of B were “Opera Solutions Private Limited,” then the true textual representation of the entity Opera Solutions would be defined as “Opera Solutions Management Consulting Private Limited.” For every (Aᵢ, Bⱼ) pair that “match,” there would exist an element Cₖ in C such that the true textual representation of Cₖ is (Aᵢ∪Bⱼ).

Errors are assumed to follow a Poisson distribution such that data entry agents make r token deletes for every token that should have been entered. Under these assumptions, two given names Aᵢ and Bⱼ match if they were both entered while intending to enter (Aᵢ∪Bⱼ). Thus, the errors made in entering Aᵢ are |Aᵢ∪Bⱼ|−Aᵢ, and similarly for Bⱼ. Using the Poisson probability mass function (pmf), the probability that in two trials a data entry agent ended up entering Aᵢ and Bⱼ when trying to enter (Aᵢ∪Bⱼ) becomes:

$${P}_{ij} = \frac{{λ}^{{k}_{A} + {k}_{B}} {e}^{- 2 λ}}{{k}_{A} ! {k}_{B} !} \qquad Equation 1$$

where λ=r|Aᵢ∪Bⱼ| is the expected number of token deletes in one trial, k_{A}=|Aᵢ∪Bⱼ|−|Aᵢ| is the actual number of token deletes in the first trial, and k_{B}=|Aᵢ∪Bⱼ|−|Bⱼ| is the actual number of token deletes in the second trial. The parameter r depends on the quality of data entry, and is lower when the consistency of the data entry agents is higher. These probabilities are ranked in descending order and, starting at the top, are confirmed as matches in descending order until a probability threshold is reached.

Some of the assumptions made in step 20 do not accurately reflect real world behavior. For instance, the assumption that an agent would delete any token from the “true” name with equal likelihood is unrealistic (e.g., for “Opera Solutions Management Consulting Private Limited,” the token “Limited” would not be missing just as often as “Opera”), and leads to inaccurate results (e.g., “Opera Mgmt. Pvt. Ltd. Co.” and “Femrose Pvt. Ltd. Co.” have an 80% match, while “Opera Mgmt. Pvt. Ltd. Co.” and “Opera Inc.” have a 20% match). Accordingly, delete rate r must vary with each token because, in actuality, tokens that uniquely identify an entity are less likely to be missing (i.e., delete rate r would be lower) than tokens that commonly occur in different entities.

Consequently, the process proceeds to step 22, and assumptions are enhanced from information retrieval concepts based on real world behavior, such as by the application of the Inverse Document Frequency function to vary the likelihood of token deletion. Jaccard Similarity is then defined as the ratio of the sizes of the intersection and union sets of the two sets of tokens Aᵢ and Bⱼ that the model is attempting to match. Approximately the same rank ordering is maintained when Equation 1 is replaced with the following equation defining Jaccard Similarity of any pair of sets A and B:

$${J}_{ij} := {P}_{ij}^{′} = \frac{\vert {A}_{i} ⋂ {B}_{j} \vert}{\vert {A}_{i} ⋃ {B}_{j} \vert} \qquad Equation 2$$

Relying on Stirling's approximation of factorials for sequencing, if d:=|Aᵢ∪Bⱼ| and n:=|Aᵢ∩Bⱼ|, then in most cases (since n≦d) the following apply:

$$\begin{matrix} & Equations 3 and 4 \\ \frac{\partial {P}_{ij}}{\partial n} > 0 & ( 3 ) \\ \frac{\partial {P}_{ij}}{\partial d} < 0 & ( 4 )\end{matrix}$$

These same relations trivially hold true for Pᵢⱼ′, which is one of the simplest functions to have this property. Another important reason for using Pᵢⱼ′ is that it has been known in practice to work well in set matching problems. However, direct Jaccard Similarity is only accurate with a very simplistic transformation model (e.g., when the only mistakes made by the person typing in data are token addition/deletion, and where the likelihood of adding/deleting any token is the same).

As a result, to account for different tokens that have different likelihoods of being deleted, weighted cardinalities for Jaccard Similarity are used, where each token is weighted by how uniquely it can be used to identify a single name (i.e., the more frequently that a token occurs in a dataset, the less weight that is provided to that token by the system). In this way, each element in the intersection and union sets are weighted by their “discrimination ability.”One such weighting function is a modified Inverse Document Frequency (IDF) function, as follows:

$${IDF}^{′} ( t ) = 1 - \frac{log ( {f}_{t} + 1 )}{log ( {f}_{max} + 1 )} \qquad Equation 5$$

where fₜ is the number of strings in which the token t occurs and fₘₐₓ is the frequency of the most commonly occurring token. This modified version has many desirable properties, such as being bounded between 0 and 1, and is robust to numerous probability models for word frequencies, etc. This modified form of the IDF function is then incorporated into the Jaccard Similarity, so that the modified Jaccard Similarity between two names A and B then becomes:

$${J}_{ij}^{′} = \frac{{\sum }_{t ∈ {A}_{i} ⋂ {B}_{j}}^{ } {IDF}^{′} ( t )}{{\sum }_{t ∈ {A}_{i} ⋃ {B}_{j}}^{ } {IDF}^{′} ( t )} \qquad Equation 6$$

Rank ordering matches using Equation 6 give much better results than Equation 1 because of the IDF customized delete rates.

In step 24, one or more token similarity measures/metrics are applied to account for token misspellings (i.e., a token that appears as a modified version of the original, such as by typographical error) by calculating token misspelling match probabilities, or the probability of any token belonging to a dataset. Such measures can be broadly classified as either unintentional errors or intentional spelling variations. Unintentional errors occur when an agent entered something not intended (e.g., “Oper” instead of “Opera”), and can be handled using one or more character sequence similarity algorithms, discussed below. Intentional spelling variations occur when an agent entered exactly what was intended, but the spelling was incorrect (e.g., from use of a different language or sounding out the word), and can be handled using one or more similarity of sound algorithms, discussed below.

Metrics/measures 28 that address unintentional errors, such as unintentional typographical mistakes, include Longest Common Subsequence metrics/measures 32, Jaro Winkler Distance measures/metrics 34, and Levenshtein Edit Distance metrics/measures 36. The Longest Common Subsequence (LCS) metrics/measures 32 measure the length of the longest subsequence of characters common to both strings. It is usually normalized by the length of the shorter string. The Jaro Winkler Distance metrics/measures 34 are a measure of similarity between two strings. It is a variant of the Jaro distance metric and mainly used in the area of record linkage (i.e., duplicate detection). The score is normalized such that 0 equates to no similarity and 1 is an exact match. The measure incorporates the fact that errors are less likely to be made in the first few characters of a token, and chances of error increase farther along a string. The Levenshtein Edit Distance (LED) metrics/measures 36 represent the minimum number of single-character edits needed to transform one string into another. For example, the distance between “kitten” and “sitting” is 3, since three edits is the minimum number of edits to change one into the other (e.g., (1) kitten→sitten (substitution of ‘s’ for ‘k’), (2) sitten→sittin (substitution of ‘i’ for ‘e’), (3) sittin→sitting (insertion of ‘g’ at the end)).

Metrics/measures 30 that address intentional spelling variations, such as where the agent's spelling based on “sounding out” the word was incorrect, include “soundex algorithm” 38 and double metaphone algorithm 40. Soundex algorithm 38 is a phonetic algorithm for indexing names by sound, as pronounced in English, which mainly encodes consonants, so that a vowel will not be encoded unless it is a first letter. The goal is for homophones to be encoded to the same representation so that they can be matched despite minor differences in spelling. Improvements to the soundex algorithm 38 are the basis for many modern phonetic algorithms. Double metaphone algorithm 40, an improvement of the metaphone algorithm which is in turn derived from soundex algorithm 38, is one of the most advanced phonetic algorithms. It is called “Double” because it can return both a primary and a secondary code for a string. It tries to account for a myriad of irregularities in English of Slavic, Germanic, Celtic, Greek, French, Italian, Spanish, Chinese, and other origins. Thus, it uses a much more complex rule set for coding than its predecessor (e.g., tests for approximately 100 different contexts of the use of the letter C alone). It is anticipated that the invention may also normalize all common abbreviations/synonyms to one form. Further, it is anticipated that stemming may be used so that different forms of words could be normalized to the same entity (e.g., buying and buy; designs and design, etc.).

In step 26, using the calculated token misspelling match probabilities of step 24, the model is generalized to account for token misspellings. One way to generalize the model for token misspelling is to treat both the numerator and denominator of Equation 6 (i.e., the weighted cardinalities of A∩B and A∪B) as random variables, and compute their expectation values. Consider two strings Aᵢ={a₁ . . . aₙ} and Bⱼ={b₁ . . . b^{m}} as sets of tokens (with n≧m). To find the shortest path from A to B the m closest (a, b) pairs are found and greedy selection is employed. The remaining n-m elements of Aᵢ that do not make it to any such token pair, must always be considered as unmatched. Given these m possible pairs of tokens matching, there are 2^{m} possible intersection and union sets of A₁ and Bⱼ, each case being driven by the sequence of matching and non-matching pairs. For each case, the IDFs of the intersection and union sets, and hence their expectation values, may be computed.

For example, consider the two strings “Opera Solutions” and “Oper Solutions.” The closest token pairs greedily identified from this pair of strings would be (“Opera”, “Oper”) and (“Solutions”, “Solutions”). As a result, there are four possible intersection sets: { }; {“Opera”}; {“Solutions”}; {“Opera”,“Solutions”}. Assume, using the measures discussed in step 24, the probability of each pair actually referring to the same thing is P₁₁=0.6 for the first pair and P₂₂=0.75 for the second pair. Set 3 ({“Solutions”}) will occur when the pair (“Solutions”,“Solution”) matches and the pair (“Opera”,“Oper”) does not match, with a probability of P₂₂(1−P₁₁)=0.3. For each of these four cases, a corresponding union is set, as well as a Jaccard Similarity (i.e., Jᵢⱼ′ from Equation 6). Knowing the probabilities and J′ for each case, the expectation value of J′ (weighted average) with a computation scale of O(2^{m}) is easily found.

To computer the expectation value of J′ using the method described above, 2^{m} computations would be required for every pair of strings A, B. To increase matching efficiency, the expectation value of J′ with O(m) computations is computed. For this purpose, consider m independent random variables, such that each variable xᵢ takes values from {0, vᵢ}, where vᵢ occurs with probability Pᵢ. Then:

E(Σxᵢ)=ΣPᵢvᵢ Equation 7

This can be easily proven using induction. Consider the numerator of Equation 6, so that for every pair i: (a, b) that matches, one element is added to the intersection set, and one term is added to the numerator. Thus, each term in the numerator summation is considered as a random variable that takes values 0 or IDFᵢ≡min(IDF(a),IDF(b)), based on whether or not the corresponding pair matches. The expectation value of the numerator of Equation 6 is found as ΣPᵢIDFᵢ, and the expectation value of the denominator would be:

$${\sum }_{a ∈ A}^{ } IDF ( a ) + {\sum }_{b ∈ B}^{ } IDF ( b ) - {\sum }_{ }^{ } {P}_{i} {IDF}_{i} \qquad Equation 8$$

For example, assume the token {opera, solutions, pvt, ltd} is defined by A={a₁,a₂,a₃,a₄} and {oper, solutions, pte} is defined by B={b₁,b₂,b₃}. Assume the three best matches (in terms of token match probabilities) are a₁-b₁, a₂-b₂,a₃-b₃. Corresponding to these matches, the best token match probabilities are P₁₁,P₂₂,P₃₃, with P₁₁˜0.9, P₂₂=1.0 and P₃₃˜0.1. Define IDF₁₁=min(IDF′(a₁),IDF′(b₁)) and I̅D̅F̅₁₁′=max (IDF′(a₁),IDF′(b₁)), so that the similarity between A and B may be computed as:

$${J}^{″} ( A , B ) = \frac{{P}_{11} {IDF}_{11}^{′} + {P}_{22} {IDF}_{22}^{′} + {P}_{33} {IDF}_{33}^{′}}{\begin{matrix}( {IDF}_{11}^{′} + ( 1 - {P}_{11} ) {\overline{IDF}}_{11}^{′} ) + \\ ( {IDF}_{22}^{′} + ( 1 - {P}_{22} ) {\overline{IDF}}_{22}^{′} ) + \\ ( {IDF}_{33}^{′} + ( 1 - {P}_{33} ) {\overline{IDF}}_{33}^{′} ) + {IDF}^{′} ( {a}_{4} )\end{matrix}} \qquad Equation 9$$

It should be noted that the expression above is exactly the ratio of the expectation values of the IDF weighted cardinalities of A∩B and A∪B.

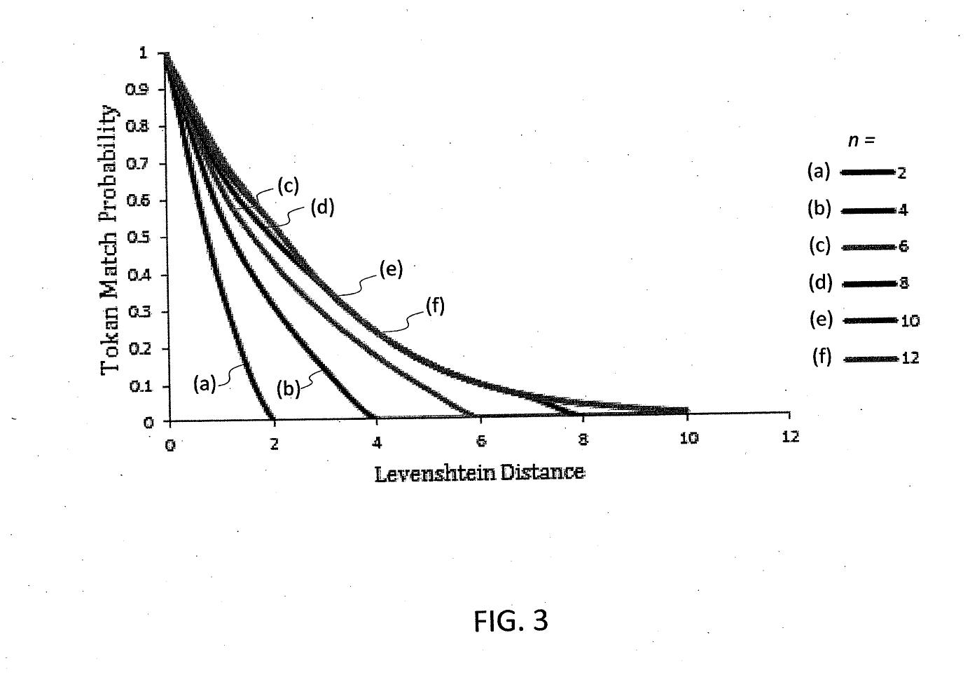

The present invention was tested using two scenarios. In both scenarios, the data was pre-processed by text fingerprinting, and a variant of the Levenshtein Edit Distance measure/metric was used as the character sequence similarity measure, so that the likelihood that two tokens matched was:

$${P}_{ab} = min ( 2 ( 1 - ( \frac{1}{1 + {e}^{( - 0.5 d )}} ) ) , \\ max ( 1 - ( \frac{log ( d + 1 )}{log ( n + 1 )} ) , 0 ) ) \qquad Equation 10$$

where d is the Levenshtein distance between tokens a and b, and the length (i.e., number of characters) of the shorter token is n. This is represented graphically in FIG. 3. It is anticipated that other similarity measures could be used as well (e.g., LCS, DL distance, Double Metaphone), and perhaps the maximum among them used.

In the first test, the goal was to consolidate independently-collected web usage data and sales data, with no explicit linking key between the two data sets, and where the only possible matching key was manually entered company names. The company names were in two datasets of sizes 4,211 and 21,760 respectively, corresponding to 92×10⁶ possible matches to evaluate in a many to many relationship.

The total number of matches eventually found were 6,064, where only 2,578 pairs matched exactly. Hence, the fuzzy text matching model of the system was responsible for finding 57% of all the matches found. These matches covered 4,037 unique companies, hence covering at least 96% of matchable entities. The rate of false positives was estimated at 1.5%, giving the algorithm a precision of 98.5%. Table 1 lists some examples of these approximate matches.

TABLE 2

| DATASET1 | DATASET2 |
|---|---|
| AMC Textil- Colcci | Anthurium Textile - Colcci |
| | Europe |
| Rubbermaid Consumer | Curver BV (Rubbermaid) |
| Wilsons The Leather Experts | Wilson's Leather |
| Inc. | |
| Fabrica srl | Fabrika |
| PRL - Lauren Dresses | Polo Ralph Lauren (PRL) |
| Impulse International Pvt Ltd | Impulse Products |

However, these match rates were achieved without tweaking the system in any way to suit this particular dataset (e.g., hardcoded rules about the specific consolidation problem), indicating the possibility that performance would be similar on other matching tasks as well.

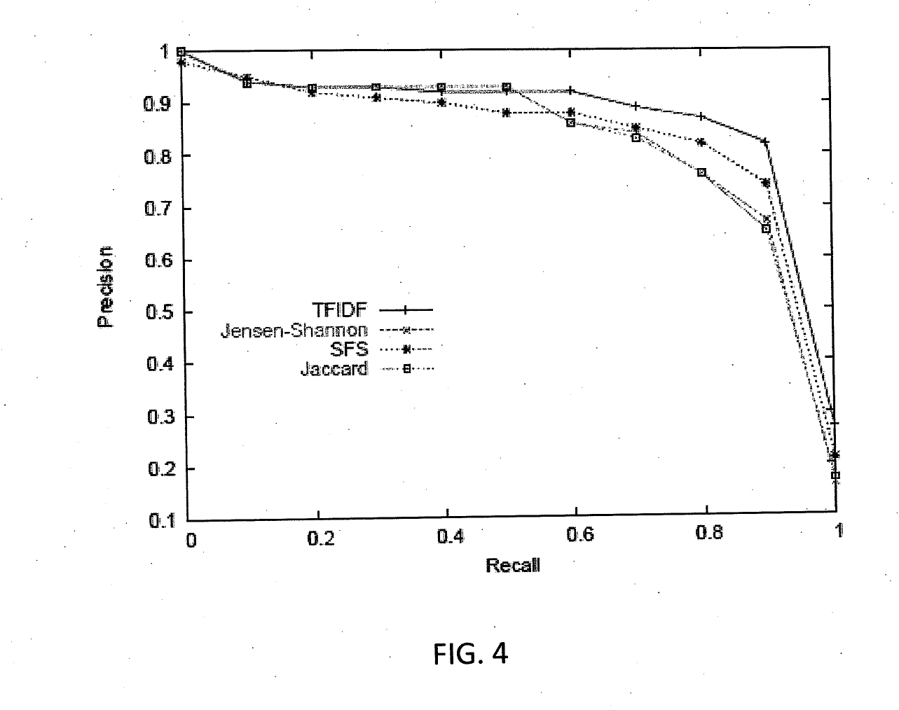

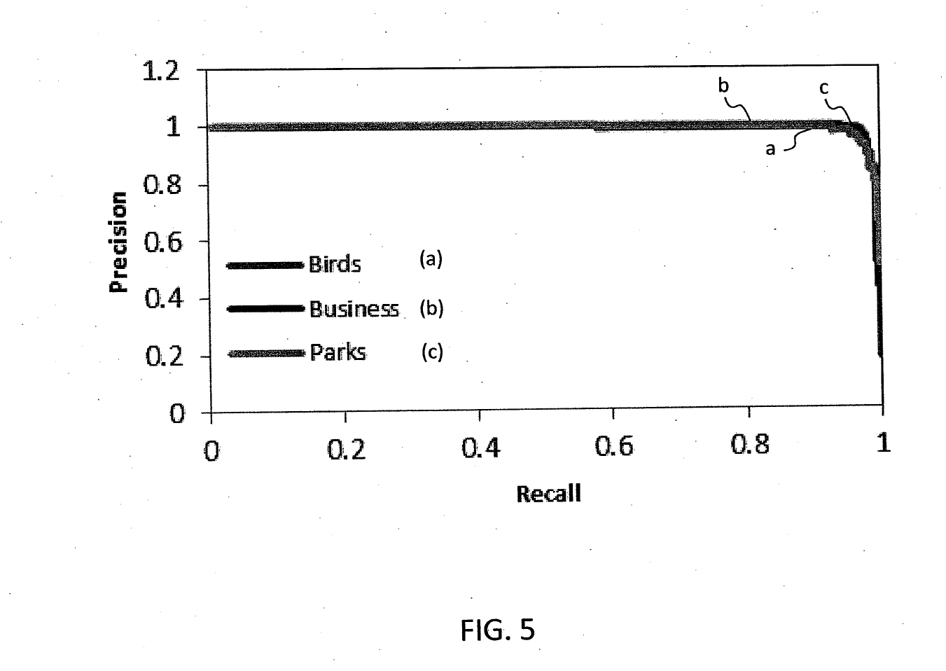

In the second test, the present invention was applied to a set of benchmark matching datasets against popular matching algorithms. The datasets used were those employed for comparing popular record linking algorithms in W. W. Cohen, et al., “A comparison of string distance metrics for name-matching tasks,” in “Proceedings of the IJCAI-2003 Workshop on Information Integration on the Web (IIWeb-03)” (2003), the entire disclosure of which is expressly incorporated herein by reference. Precision recall curves were used as the performance metric, which sorted all matches in descending order by match score, and plotted precision against recall at every rank. FIG. 4 is a graph illustrating the average precision-recall performance of selected current string similarity metrics (e.g., term frequency-inverse document frequency (TFIDF), Jenson-Shannon, sequential forward selection (SFS), and Jaccard) on a benchmark dataset of Cohen, et al. By comparison, FIG. 5 is a graph illustrating the precision-recall performance of the data matching system of the present invention on 3 of the benchmark datasets of Cohen, et al. (specifically, bird names, U.S. park names, and company names). Based on the results, the system of the present invention outperforms the other tested algorithms.

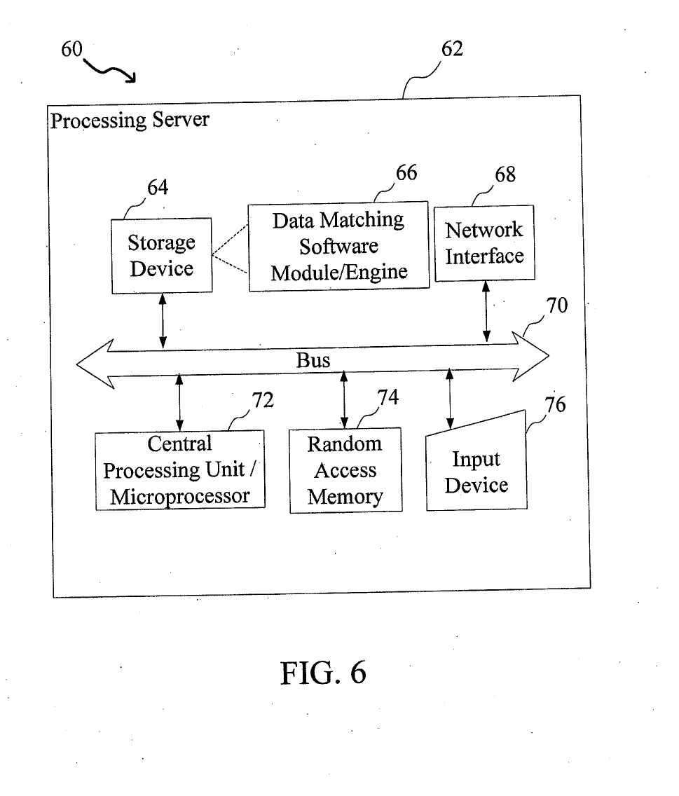

FIG. 6 is a diagram showing hardware and software components of the system 60 capable of performing the processes discussed in FIGS. 1 and 2 above. The system 60 comprises a processing server 62 (computer) which could include a storage device 64, a network interface 68, a communications bus 70, a central processing unit (CPU) (microprocessor) 72, a random access memory (RAM) 74, and one or more input devices 76, such as a keyboard, mouse, etc. The server 62 could also include a display (e.g., liquid crystal display (LCD), cathode ray tube (CRT), etc.). The storage device 64 could comprise any suitable, computer-readable storage medium such as disk, non-volatile memory (e.g., read-only memory (ROM), eraseable programmable ROM (EPROM), electrically-eraseable programmable ROM (EEPROM), flash memory, field-programmable gate array (FPGA), etc.). The server 62 could be a networked computer system, a personal computer, a smart phone, etc.

The present invention could be embodied as a data matching software module or engine 66, which could be embodied as computer-readable program code stored on the storage device 64 and executed by the CPU 92 using any suitable, high or low level computing language, such as Java, C, C++, C#, .NET, etc. The network interface 68 could include an Ethernet network interface device, a wireless network interface device, or any other suitable device which permits the server 62 to communicate via the network. The CPU 72 could include any suitable single- or multiple-core microprocessor of any suitable architecture that is capable of implementing and running the detection program 66 (e.g., Intel processor). The random access memory 74 could include any suitable, high-speed, random access memory typical of most modern computers, such as dynamic RAM (DRAM), etc.

Having thus described the invention in detail, it is to be understood that the foregoing description is not intended to limit the spirit or scope thereof. It will be understood that the embodiments of the present invention described herein are merely exemplary and that a person skilled in the art may make any variations and modification without departing from the spirit and scope of the invention. All such variations and modifications, including those discussed above, are intended to be included within the scope of the invention. What is desired to be protected is set forth in the following claims.

What is claimed is:

1. A system for matching data comprising:
a computer system for electronically receiving a dataset;
a near-exact matching model, executed by the computer system, which pre-processes the dataset to generate a plurality of text strings and compares the text strings to identify matching data in the dataset;
a fingerprint matching model, executed by the computer system, which converts each entry of the dataset into a corresponding text fingerprint and compares resultant text fingerprints to identify matching data in the dataset; and
a fuzzy text matching model, executed by the computer system, which applies probabilistic modeling techniques to the dataset to identify matching data in the dataset,
wherein the system transmits the matching data to a user.

2. The system of claim 1, wherein the dataset comprises short string text.

3. The system of claim 1, wherein the near-exact matching model removes all non alpha-numeric characters and sets every remaining character to lowercase.

4. The system of claim 1, wherein the fingerprint matching model applies a key collision method of clustering to the dataset.

5. The system of claim 1, wherein the system removes all matches detected by the near-exact matching model and the fingerprint matching model prior to executing the fuzzy text matching model.

6. The system of claim 1, wherein the probabilistic modeling techniques applied by the fuzzy text matching model include at least one of:
developing a simple probabilistic model;
applying an inverse document frequency function to vary the likelihood of token deletion;
applying one or more token similarity metrics to calculate token misspelling match probabilities; and
generalizing the fuzzy text matching model for token misspellings.

7. The system of claim 6, wherein the one or more token similarity metrics includes one or more unintentional errors metrics.

8. The system of claim 7, wherein the one or more unintentional errors metrics includes at least one of Longest Common Subsequence metrics, Jaro Winkler Distance Metrics, or Levenshtein Edit Distance Metrics.

9. The system of claim 6, wherein the one or more token similarity metrics includes one or more intentional spelling variations metrics.

10. The system of claim 9, wherein the one or more intentional variation metrics includes at least one of a soundex algorithm or a double metaphone algorithm.

11. A method for matching data comprising the steps of:
electronically receiving a dataset at a computer system;
executing on the computer system a near-exact matching model which pre-processes the dataset to generate a plurality of text strings and compares the text strings to identify matching data in the dataset;
executing on the computer system a fingerprint matching model, executed by the computer system, which converts each entry of the dataset into a corresponding text fingerprint and compares resultant text fingerprints to identify matching data in the dataset;
executing on the computer system a fuzzy text matching model which applies probabilistic modeling techniques to the dataset to identify matching data in the dataset; and
transmitting any matching data identified by the system to a user.

12. The method of claim 11, wherein the dataset comprises short string text.

13. The method of claim 11, wherein the near-exact matching model removes all non alpha-numeric characters and sets every remaining character to lowercase.

14. The method of claim 11, wherein the fingerprint matching model applies a key collision method of clustering to the dataset.

15. The method of claim 11, further comprising removing all matches detected by the near-exact matching model and the fingerprint matching model before executing the fuzzy text matching model.

16. The method of claim 11, wherein the probabilistic modeling techniques applied by the fuzzy text matching model include at least one of:
developing a simple probabilistic model;
applying an inverse document frequency function to vary the likelihood of token deletion;
applying one or more token similarity metrics to calculate token misspelling match probabilities; and
generalizing the fuzzy text matching model for token misspellings.

17. The method of claim 16, wherein the one or more token similarity metrics includes one or more unintentional errors metrics.

18. The method of claim 17, wherein the one or more unintentional errors metrics includes at least one of Longest Common Subsequence metrics, Jaro Winkler Distance Metrics, or Levenshtein Edit Distance Metrics.

19. The method of claim 16, wherein the one or more token similarity metrics includes one or more intentional spelling variations metrics.

20. The method of claim 19, wherein the one or more intentional variation metrics includes at least one of a soundex algorithm or a double metaphone algorithm.

21. A computer-readable medium having computer-readable instructions stored thereon which, when executed by a computer system, cause the computer system to perform the steps of:
electronically receiving a dataset at the computer system;
executing on the computer system a near-exact matching model which pre-processes the dataset to generate a plurality of text strings and compares the text strings to identify matching data in the dataset;
executing on the computer system a fingerprint matching model which converts each entry of the dataset into a corresponding text fingerprint and compares resultant text fingerprints to identify matching data in the dataset;
executing on the computer system a fuzzy text matching model which applies probabilistic modeling techniques to the dataset to identify matching data in the dataset; and
transmitting any matching data identified by the system to a user.

22. The computer-readable medium of claim 21, wherein the dataset comprises short string text.

23. The computer-readable medium of claim 21, wherein the near-exact matching model removes all non alpha-numeric characters and sets every remaining character to lowercase.

24. The computer-readable medium of claim 21, wherein the fingerprint matching model applies a key collision method of clustering to the dataset.

25. The computer-readable medium of claim 21, further comprising removing all matches detected by the near-exact matching model and the fingerprint matching model before executing the fuzzy text matching model.

26. The computer-readable medium of claim 21, wherein the probabilistic modeling techniques applied by the fuzzy text matching model include at least one of:
developing a simple probabilistic model;
applying an inverse document frequency function to vary the likelihood of token deletion;
applying one or more token similarity metrics to calculate token misspelling match probabilities; and
generalizing the fuzzy text matching model for token misspellings.

27. The computer-readable medium of claim 26, wherein the one or more token similarity metrics includes one or more unintentional errors metrics.

28. The computer-readable medium of claim 27, wherein the one or more unintentional errors metrics includes at least one of Longest Common Subsequence Metrics, Jaro Winkler Distance Metrics, or Levenshtein Edit Distance Metrics.

29. The computer-readable medium of claim 26, wherein the one or more token similarity metrics includes one or more intentional spelling variations metrics.

30. The computer-readable medium of claim 29, wherein the one or more intentional variation metrics includes at least one of a soundex algorithm or a double metaphone algorithm.

31. A method for matching data comprising the steps of:
electronically receiving a dataset at a computer system;
executing on the computer system a fuzzy text matching model which applies probabilistic modeling techniques to the dataset to identify matching data in the dataset; and
transmitting any matching data identified by the system to a user.

32. The method of claim 31, further comprising executing by the computer system a near-exact matching model which pre-processes the dataset to generate a plurality of text strings and compares the text strings to identify matching data in the dataset.

33. The method of claim 31, further comprising executing by the computer system a fingerprint matching model which converts each entry of the dataset into a corresponding text fingerprint and compares resultant text fingerprints to identify matching data in the dataset;

34. The method of claim 31, wherein the dataset comprises short string text.

35. The method of claim 31, wherein the probabilistic modeling techniques applied by the fuzzy text matching model include at least one of:
developing a simple probabilistic model;
applying an inverse document frequency function to vary the likelihood of token deletion;
applying one or more token similarity metrics to calculate token misspelling match probabilities; and
generalizing the fuzzy text matching model for token misspellings.

36. The method of claim 35, wherein the one or more token similarity metrics includes one or more unintentional errors metrics.

37. The method of claim 36, wherein the one or more unintentional errors metrics includes at least one of Longest Common Subsequence metrics, Jaro Winkler Distance Metrics, or Levenshtein Edit Distance Metrics.

38. The method of claim 35, wherein the one or more token similarity metrics includes one or more intentional spelling variations metrics.

39. The method of claim 38, wherein the one or more intentional variation metrics includes at least one of a soundex algorithm or a double metaphone algorithm.
